(19) United States
(12) Patent Application Publication
(10) Pub. No.: US 2025/0088718 A1
(43) Pub. Date: Mar. 13, 2025

(54) CONTENT TRANSMISSION METHOD AND APPARATUS, DEVICE AND STORAGE MEDIUM

(71) Applicant: Lemon Inc., Grand Cayman (KY)

(72) Inventors: Yifan YANG, Beijing (CN); Lei MA, Beijing (CN); Luyu LI, Beijing (CN); Haiyu TANG, Beijing (CN)

(21) Appl. No.: 18/827,217

(22) Filed: Sep. 6, 2024

(30) Foreign Application Priority Data
Sep. 7, 2023 (CN) 202311154129.3

(51) Int. Cl. H04N 21/845; H04L 67/02; H04N 21/84

(52) U.S. Cl. CPC H04N 21/845; H04L 67/02; H04N 21/84

(57) ABSTRACT

The embodiment of the disclosure provides a content transmission method and apparatus, a device and a storage medium. The method includes: in response to receiving a first request for content from a client, obtaining a plurality of pieces of content, wherein the first request comprises a user identifier; splitting the plurality of pieces of content into a plurality of groups of content; transmitting a first group of content in the plurality of groups of content to the client; storing other groups of content in the plurality of groups of content; and in response to receiving a second request comprising the user identifier for the content from the client, transmitting a second group of content in the stored other groups of content to the client. Therefore, the efficiency of content transmission is improved.

### CROSS-REFERENCE

The present application claims priority to Chinese Patent Application No. 202311154129.3, filed on Sep. 7, 2023 and entitled “CONTENT TRANSMISSION METHOD AND APPARATUS, DEVICE AND STORAGE MEDIUM”, the entirety of which is incorporated herein by reference. FIELD

Example embodiments of the disclosure generally relate to the field of computers, and in particular, to a content transmission method and apparatus, device, and computer-readable storage medium.

### BACKGROUND

Content transmission widely exists in various applications where users can perform content accessing operations, such as reviewing news. After receiving a content accessing request from a client, a server transmits content to the client for viewing by the user. In the content transmission process, it is often necessary to overcome the problem of low transmission efficiency during peak network usage period or in a case of network instability condition, and it is expected that efficient content transmission can be achieved.

### SUMMARY

In a first aspect of the disclosure, a method for content transmission is provided. The method includes: in response to receiving a first request for content from a client, obtaining a plurality of pieces of content, wherein the first request comprises a user identifier; splitting the plurality of pieces of content into a plurality of groups of content; transmitting a first group of content in the plurality of groups of content to the client; storing other groups of content in the plurality of groups of content; and in response to receiving a second request comprising the user identifier for the content from the client, transmitting a second group of content in the stored other groups of content to the client.

In a second aspect of the disclosure, a method for content transmission is provided. The method includes: in response to receiving a request for content from a client, forwarding the request to a content providing server, wherein the request comprising a request identifier; in response to receiving a group of content from the content providing server, storing the group of content; forwarding the group of content to the client; and in response to receiving a second request comprising the user identifier for the content from the client, transmitting a second group of content in the stored other groups of content to the client.

In a third aspect of the disclosure, a method for content transmission is provided. The method includes: transmitting a first request for content to a content distribution network, the first request comprising a user identifier; receiving a first group of content in a plurality of groups of content from the content distribution network; transmitting a second request for the content to the content distribution network, the second request comprising the user identifier; and receiving a second group of content in the plurality of groups of content from the content distribution network.

In a fourth aspect of the disclosure, a method for content transmission is provided. The method includes: transmitting a request for content to a content distribution network, the request comprising a request identifier; in response to determining that an error occurs with the request, transmitting another request for content to the content distribution network, the another request comprising the request identifier; and receiving a group of content from the content distribution network.

In a fifth aspect of the disclosure, an apparatus for content transmission is provided. The apparatus includes: a content obtaining module, configured to obtain, in response to receiving a first request for content from a client, a plurality of pieces of content, wherein the first request comprises a user identifier; a content splitting module, configured to split the plurality of pieces of content into a plurality of groups of content; a first transmitting module, configured to transmit a first group of content in the plurality of groups of content to the client; a first storing module, configured to store other groups of contents in the plurality of groups of contents; and a second transmitting module, configured to transmit, in response to receiving a second request comprising the user identifier for the content from the client, a second group of content in the stored other groups of content to the client.

In a sixth aspect of the disclosure, an apparatus for content transmission is provided. The apparatus includes: a request forwarding module, configured to forward, in response to receiving a request for content from a client, forwarding the request to a content providing server, wherein the request comprising a request identifier; a second storing module, configured to store, in response to receiving a group of content from the content providing server, the group of content; a content forwarding module, configured to forward the group of content to the client; and a content transmitting module, configured to transmit, in response to receiving another request comprising the request identifier for the content from the client, the stored group of content to the client.

In a seventh aspect of the disclosure, an apparatus for content transmission is provided. The apparatus includes: a first requesting module, configured to transmit a first request for content to a content distribution network, the first request comprising a user identifier; a first receiving module, configured to receive a first group of content in a plurality of groups of content from the content distribution network; a second request module, configured to transmit a second request for the content to the content distribution network, the second request comprising the user identifier; and a second receiving module, configured to receive a second group of content in the plurality of groups of content from the content distribution network.

In an eighth aspect of the disclosure, an apparatus for content transmission is provided. The apparatus includes: a third requesting module, configured to transmit a request for content to a content distribution network, the request comprising a request identifier; a fourth requesting module, configured to transmit, in response to determining that an error occurs with the request, another request for content to the content distribution network, the another request comprising the request identifier; and a third receiving module, configured to receive a group of content from the content distribution network.

In a ninth aspect of the disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect, the second aspect, the third aspect, or the fourth aspect.

In a tenth aspect of the disclosure, a computer-readable storage medium is provided. The computer-readable storage medium stores a computer program, and the computer program may be executed by a processor to implement the method according to the first aspect, the second aspect, the third aspect, or the fourth aspect.

It should be appreciated that the content described in this section is not intended to limit critical features or essential features of the embodiments of the disclosure, nor is it intended to limit the scope of the disclosure. Other features of the disclosure will become readily appreciated from the following description.

### BRIEF DESCRIPTION OF DRAWINGS

The above and other features, advantages, and aspects of various embodiments of the disclosure will become more apparent with reference to the following detailed description in conjunction with the accompanying drawings. In the drawings, the same or similar reference numerals denote the same or similar elements, wherein:

FIG. 1 illustrates a schematic diagram of an example environment in which embodiments of the disclosure can be implemented;

FIG. 2 illustrates a flowchart of a content transmission method according to some embodiments of the disclosure;

FIG. 3 illustrates a flowchart of a content transmission method according to some other embodiments of the disclosure;

FIG. 4 illustrates a flowchart of a content transmission method according to still other embodiments of the disclosure;

FIG. 5 illustrates a flowchart of a content transmission method according to some other embodiments of the disclosure;

FIG. 6 illustrates a schematic flowchart of a content transmission process according to some embodiments of the disclosure;

FIG. 7 illustrates a schematic structural block diagram of a content transmission apparatus according to some embodiments of the disclosure;

FIG. 8 illustrates a schematic structural block diagram of a content transmission apparatus according to another embodiment of the disclosure;

FIG. 9 illustrates a schematic structural block diagram of a content transmission apparatus according to still other embodiments of the disclosure;

FIG. 10 illustrates a schematic structural block diagram of a content transmission apparatus according to some other embodiments of the disclosure; and

FIG. 11 illustrates a block diagram of an electronic device capable of implementing one or more embodiments of the disclosure.

### DETAILED DESCRIPTION

It will be appreciated that, before using the technical solutions disclosed in the various embodiments of the disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It will be appreciated that the above notification and user authorization process are only illustrative which do not limit the implementation of this disclosure. Other methods that meet relevant laws and regulations can also be applied to the implementation of this disclosure.

It will be appreciated that the data involved in the technical solution (including but not limited to the data itself, the obtaining or use of the data) should comply with the requirements of the corresponding legal regulations and related provisions.

The following will describe the embodiments of the disclosure in more detail with reference to the accompanying drawings. Although some embodiments of the disclosure are shown in the drawings, it shall be understood that the disclosure can be implemented in various forms and should not be construed as limited to the embodiments set forth herein. On the contrary, these embodiments are provided for a more thorough and complete understanding of the disclosure. It shall be understood that the drawings and embodiments of the disclosure are provided for illustrative purposes only and are not intended to limit the scope of protection of the disclosure.

It should be noted that the headline of any section/subsection provided herein is not limiting. Various embodiments are described throughout this disclosure and any type of embodiments may be included in any section/subsection. Furthermore, the embodiments described in any section/subsection may be combined in any manner with the same section/subsection and/or any other embodiment described in different sections/subsections.

In the description of the embodiments of the disclosure, the term “including” and the like should be understood as non-exclusive inclusion, that is, “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. As used herein, the term “model” may denote an association relationship between respective data. The association relationship may be obtained, for example, based on a variety of technical solutions that are currently known and/or will be developed in the future.

The term “in response to” means that a corresponding event occurs or a condition is satisfied. It will be appreciated that the execution timing of subsequent actions performed in response to the event or condition is not necessarily strongly correlated with the time when the event occurs or the condition is satisfied. In some cases, the subsequent actions may be performed immediately when an event occurs or a condition is satisfied; in other cases, the subsequent actions may also be performed after a period of time since an event occurs or a condition is satisfied.

As used herein, “content” may include various forms of data, such as news, videos, music, images, text (e.g., comments), and the like.

In some existing applications involving content transmission, the client requests mostly list-like structured data. In response to each data request from a client, a fixed amount of data, e.g., 20 news items, 20 videos, 40 comments, etc., needs to be generated synchronously in real time. In addition, each data request from the client needs to be forwarded to a server through a content distribution network device, and after the server obtains the data, the data is returned to the client through the content distribution network. This results in a longer time consuming in transmitting a larger amount of data during a peak network usage period or under an unstable network condition, which tends to cause a network request timeout, thereby generating a network error in the client. If the client cannot reuse the previously generated data after a network error occurs, the foregoing transmission process must be performed again, that is, a complete data production process is re-performed once again. This causes waste of resources in data production service and also increases the load of the data production service.

To this end, some embodiments of the disclosure provide a content transmission solution. In this solution, in response to a content providing server or a content distribution network device receiving from a client a first request for content including a user identifier, a plurality of pieces of content are obtained and split into a plurality of groups of content, and a first group of content in the plurality of groups of content is transmitted to the client and other groups of content is stored. A second group of content in the plurality of groups of content is transmitted to the client according to the second request including the user identifier and transmitted by the user.

In this way, the content providing server or the content distribution network device can split the plurality of pieces of content obtained for the request into a plurality of groups of content, one group of content is transmitted each time, which may avoid a request timeout problem that may be caused due to a long time single transmission, and thus may improve the success rate of the request. It is also possible to determine, by using the user identifier included in the subsequent request, to continue transmitting other content in the plurality group of pieces of content to the client, and there is no need to repeatedly obtain the plurality of pieces of content, to transmit each group of content in the stored plurality of pieces of content to the client according to the request, thereby improving efficiency of content transmission.

Some other embodiments of the disclosure also provide a following content transmission solution. In this solution, the client transmits a request for content including the request identifier to the content distribution network device, and the content distribution network forwards the request to the content providing server, and receives and stores one group of content returned by the content providing server. The one group of content is returned to the client. If an error occurs with the request, the client may transmit another request including the request identifier to the content distribution network device, and the content distribution network transmits the stored group of content to the client again after receiving the another request.

In this way, for a case in which an error occurs with the request at the client, the content distribution network device may transmit, according to another request transmitted by the client, a group of content stored in the content distribution network device to the client, thus there is no need to request content from the content providing server again, thereby further improving efficiency of content transmission.

Some example embodiments of the disclosure will be described below with continued reference to the accompanying drawings.

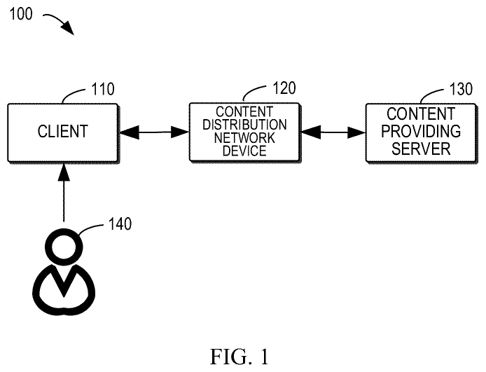

FIG. 1 illustrates a schematic diagram of an example environment 100 in which embodiments of the disclosure can be implemented. As shown in FIG. 1, in an environment 100, a client 110 may transmit a request for content to a content distribution network device 120. The content may be data that the user needs to access via the client 110 or any other suitable content.

The client 110 may be any type of device, including virtual and physical devices. By way of example, the client 110 may include, but is not limited to, a mobile device, a fixed device or a portable device, and/or the like, including a cell phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a virtual reality (VR) all-in-one machines, a game console, a game laptop, or any combination of the foregoing, including accessories and peripherals of these devices, or any combination thereof. In some embodiments, the client 110 can also support any type of interface for a user (such as a “wearable” circuit, etc.).

The content distribution network device 120 may be an edge node or an edge server in a content distribution network (CDN). The CDN is an intelligent virtual network built on the basis of an existing network, which relies on edge servers deployed in various locations and enables a user to obtain required content nearby through functional modules such as load balancing, content distribution, scheduling and the like, thus it is possible to reduce network congestion, and improves response speed and hit rate for user accessing.

The content distribution network device 120 may be implemented by any type of device, including a virtual or physical device. Examples of such device may include, but are not limited to, a mainframe, an edge computing node, a rack-mounted server, a router computer, a server computer, a personal computer, a mainframe computer, a laptop computer, a tablet computer, a desktop computer, and the like. In some embodiments, the device may include a virtual machine, a container, or a bare metal server.

After receiving the request for the content from the client 110, the content distribution network device 120 may forward the request to the content providing server 130. The content providing server 130 may be configured to provide corresponding content accessed by a client, and may be implemented by any type of device, including a virtual or physical device. Examples of such device may include, but are not limited to, a mainframe, an edge computing node, a rack-mounted server, a router computer, a server computer, a personal computer, a mainframe computer, a laptop computer, a tablet computer, a desktop computer, and the like. In some embodiments, the device may include a virtual machine, a container, or a bare metal server.

In response to receiving a request forwarded by the content distribution network device 120, the content providing server 130 obtains a plurality of pieces of corresponding content according to the request, and stores the plurality of pieces of content in the content providing server 130. The content providing server 130 may split the plurality of pieces of content into a plurality of groups of content, and transmits one group of content in the plurality of groups of content to the content distribution network device 120. After receiving the one group of content returned by the content providing server 130, the content distribution network 120 returns the received one group of content to the client 110.

It shall be understood that the structure and function of the environment 100 is described for exemplary purposes only and does not imply any limitation to the scope of the disclosure.

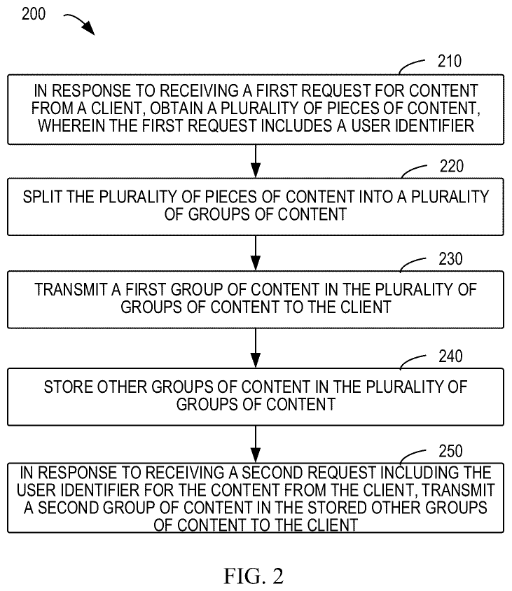

Some example embodiments of the disclosure are described below with reference to FIG. 2.

FIG. 2 illustrates a flowchart of a content transmission method 200 according to some embodiments of the disclosure. The method 200 may be performed by the content distribution network device 120 or the content providing server 130. For ease of discussion, the method 200 will be described with reference to the environment 100 of FIG. 1.

In some embodiments, at block 210, in response to receiving a first request for content from the client 110, a plurality of pieces of content is obtained. The request may be implemented in any suitable form. As an example, the request may include a hypertext transfer protocol (HTTP) request. The first request includes a user identifier, and the user identifier may be, for example, information capable of representing uniqueness of a user identity. In embodiments in which the method 200 is performed by the content distribution network device 120, the content distribution network device 120 may obtain a plurality of pieces of content through the content providing server 130. For example, in response to receiving the first request for content from the client, the content distribution network device 120 may forward the first request received from the client to the content providing server 130, and then receive a plurality of pieces of content from the content providing server 130. Taking the content being news as an example, the plurality of pieces of content may be a plurality of pieces of news, for example, 20 pieces of news.

In some other embodiments, the method 200 may be performed at the content providing server 130, that is, the content providing server 130 obtains the plurality of pieces of content in response to receiving the first request for content from the client. In some embodiments, the content providing server 130 may generate a plurality of pieces of content. For example, the content providing server 130 may generate the plurality of pieces of content in response to receiving the first request from the client 110. As an example, the content providing server 130 may access a database storing various materials, generate the requested content based on, for example, algorithms, recommendation mechanisms, and the like. Alternatively or additionally, the content providing server 130 stores various materials locally and generates corresponding content based thereon.

At block 220, the plurality of pieces of content is split into a plurality of groups of content. In some embodiments, a plurality of pieces of content may be split into a plurality of groups of content in a certain order, such as in an order in which they are intended to be presented to the user, for example, 20 pieces of news are split into 4 groups, 5 pieces of news in each group, wherein the split first group may be content that is intended to be firstly transmitted to the user, and the last group may be content in the 4 groups of news that is intended to be finally transmitted to the user. Alternatively or additionally, the splitting may be performed in an order in which the content distribution network device 120 or the content providing server 130 obtained the content. It shall be understood that any splitting manner may be used herein, and the scope of the disclosure is not limited in this respect.

At block 230, a first group of content in the plurality of groups of content is transmitted to the client 110. For example, a group of content that comes first in order in the plurality of groups of content may be transmitted to the client 110, or any group of content in the plurality of groups of content may be transmitted to the client 110. Alternatively or additionally, an indication indicating that the first group of content is part of the plurality of groups of content is transmitted to the client 110. As an example, the content distribution network device 120 or the content providing server 130 may transmit, to the client 110, an identifier indicating that the first group of content is part of the plurality of groups of content, for example, the identifier may be used to indicate that the first group of content is the first piece to fifth piece of the 20 pieces of news.

According to the embodiment of the disclosure, the obtained plurality of pieces of content can be split into a plurality of groups of content, one group of content is transmitted to the client one time, the data transmission amount corresponding to the single request is reduced, thus the success rate of obtaining corresponding content through request is improved.

At block 240, other groups of content in the plurality of groups of content is stored. In some embodiments, other groups of content are stored in association with the user identifications. As an example, a short time limited cache based on user identifier (also referred to as a first short-lived cache), such as a 5-minute short lived cache, is added in the content providing server 130. Groups of content in the plurality of groups of content other than the first group of content that has been transmitted to the client may be stored in association with user identifiers in the content distribution network device 120 or the content provisioning server 130 through the short-lived cache. In this way, when the client requests the content next time, for example, when a request with the same user identifier is received by the content distribution network device 120 or the content providing server 130, the content distribution network device 120 or the content providing server 130 does not need to obtain the content in the plurality of groups of content again, and a group of content in the cached plurality of groups of content may be directly transmitted to the client, thereby improving the efficiency of content transmission.

At block 250, in response to receiving a second request comprising the user identifier for the content from the client, a second group of content in the stored other groups of content is transmitted to the client. The second group of content may be a group of content in the plurality of groups of content that is after the first group of content in order, or any group of content other than the first group of content in the plurality of groups of content. For example, 6 to 10 of the 20 news in the above example.

According to the embodiments of the disclosure, by using the user identifier included in the second request, other stored groups of content corresponding to the user identifier may be found, and the content distribution network device 120 or the content providing server 130 does not need to obtain the content from the plurality of groups of content again, and may directly transmit the stored group of content in the plurality of groups of content to the client, thereby improving the efficiency of content transmission.

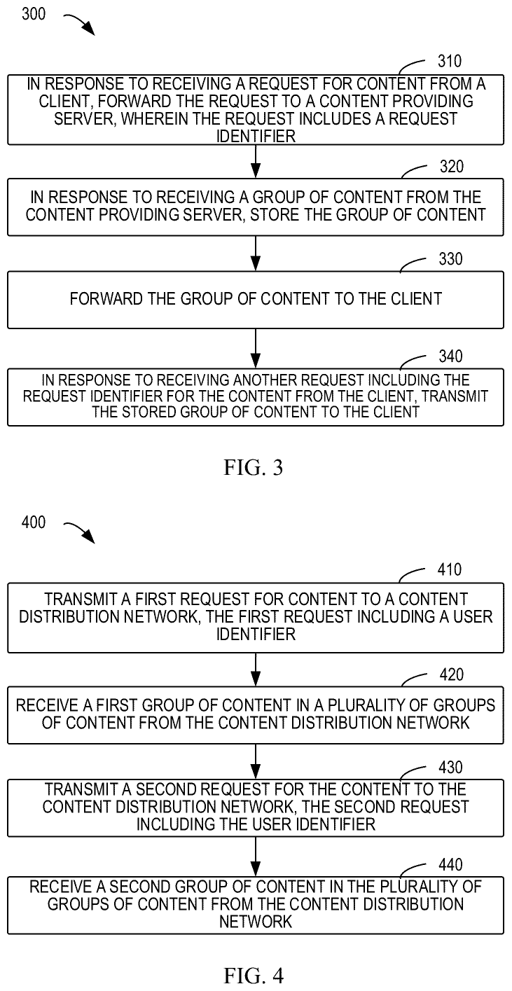

In some embodiments, the client 110 may include a request identifier in the request for content. After receiving a group of content requested by the user from the content providing server 130, the content distribution network device 120 may store the content. If an error occurs with the request, the client 110 may transmit a request containing the request identifier to the content distribution network device 120 again. After receiving the another request, the content distribution network device 120 transmits a stored group of content to the client 110 again. Some example embodiments of this aspect are described below with reference to FIG. 3.

FIG. 3 illustrates a flowchart of a content transmission method 300 according to some other embodiments of the disclosure. The method 300 may be performed by the content distribution network device 120. For ease of discussion, the method 300 will be described with reference to the environment 100 of FIG. 1.

At block 310, in response to receiving a request for content from the client 110, the request is forwarded to the content providing server 130. The request includes a request identifier, and the request identifier may be information indicating uniqueness of the request.

At block 320, in response to receiving a group of content from the content providing server 130, the group of content is stored. In some embodiments, since the content distribution network device 120 usually has a higher network quality, the success rate for requesting to return to a content distribution network is high, so that the content distribution network device 120 at an edge node of the content distribution network can be added with a shorter time limited cache based on the request identifier, for example, a 1-minute short lived cache. As an example, the group of content received from the content providing server 130 may be stored in the content distribution network device 120 through a short-lived cache. For example, the content received last 1 minutes may be cached in association with a corresponding request identifier. In some embodiments, duration of the short-lived cache at the content distribution network device 120 is not longer than duration of the short-lived cache at the content providing server 130 as described above, thereby further improving the efficiency of content transmission to the client 110.

At block 330, the group of content is forwarded to the client 110. At block 340, in response to receiving another request that includes the request identifier for the content from the client 110, the stored group of content is transmitted to the client 110. As an example, when an error occurs with the client, the client 110 may use the same request identifier as the request identifier in the request with error, to transmit another request to re-request data. As such, if the content distribution network device 120 receives another request with the same request identifier from the client 110, the content distribution network device 120 may transmit the stored group of content directly to the client 110. In this way, for such a request with error, there is no need to transmit the request to the content providing server 130 to obtain the content again. The request only needs to be transmitted to the content distribution network device 120, so that the required content can be obtained, the time required for back-to-source is reduced, and the time for reusing the content production service is shortened, thereby improving the success rate of the user retrying to request.

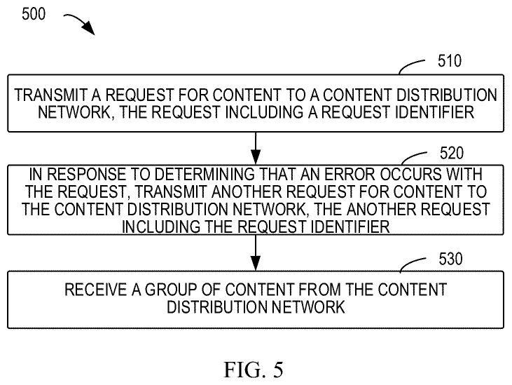

Some example embodiments at the client 110 will be described below in connection with FIGS. 4 and 5.

FIG. 4 illustrates a flowchart of a content transmission method 400 based on user identifier according to some embodiments of the disclosure. The method 400 may be performed by the client 110. For ease of discussion, the method 400 will be described with reference to the environment 100 of FIG. 1.

At block 410, a first request for content is transmitted to a content distribution network (e.g., content distribution network device 120), the first request including a user identifier. At block 420, a first group of content in a plurality of groups of content is received from a content distribution network.

In some embodiments, an indication indicating that the first the first group of content is part of the plurality of groups of content is received from the content distribution network. In an embodiment in which the content distribution network device 120 or the content providing server 130 splits a plurality of pieces of content into a plurality of groups of content (for example, 5 groups of content), the indication may indicate that the first group of content is a first group of the 5 groups of content. In this way, the client 110 may know a progress of the requested content according to the indication, that is, there are several subsequent groups of content, so that the subsequent content may continue to be requested.

At block 430, a second request for the content is transmitted to the content distribution network, the second request including a user identifier. By including the user identifier in the second request, the content distribution network device 120 or the content providing server 130 may search its cache for other groups of content in the plurality of groups of content stored corresponding to the user identifier.

At block 440, a second group of content in the plurality of groups of content is received from the content distribution network. In an embodiment where the content distribution network device 120 caches a plurality of groups of content, the second group of content may be transmitted by the content distribution network device 120 to the client 110. Alternatively or additionally, in an embodiment in which the content providing server 130 caches a plurality of groups of content, the content distribution network device 120 may forward the second request to the content providing server 130, so that the content providing server 130 searches its cache for other groups of content in the plurality of groups of content corresponding to the user identifier, and provides the other groups of content to the client 110 through the content distribution network.

FIG. 5 illustrates a flowchart of a content transmission method 500 based on a request identifier according to some embodiments of the disclosure. The method 500 may be performed by the client 110. For ease of discussion, the method 500 will be described with reference to the environment 100 of FIG. 1.

At block 510, a request for content is transmitted to a content distribution network (e.g., content distribution network device 120), the request including a request identifier. At block 520, in response to determining that an error occurs with the request, another request for content is transmitted to the content distribution network, the another request including the request identifier. At block 530, a group of content is received from a content distribution network. In an embodiment in which the content distribution network device 120 stores one group of content received from the content providing server 130 in response to the request of the client 110, the content distribution network device 120 may directly transmit the stored group of content to the client 110 based on the request identifier included in the request, thus there is no need to obtain the content from the data source end again, thereby improving efficiency of content transmission.

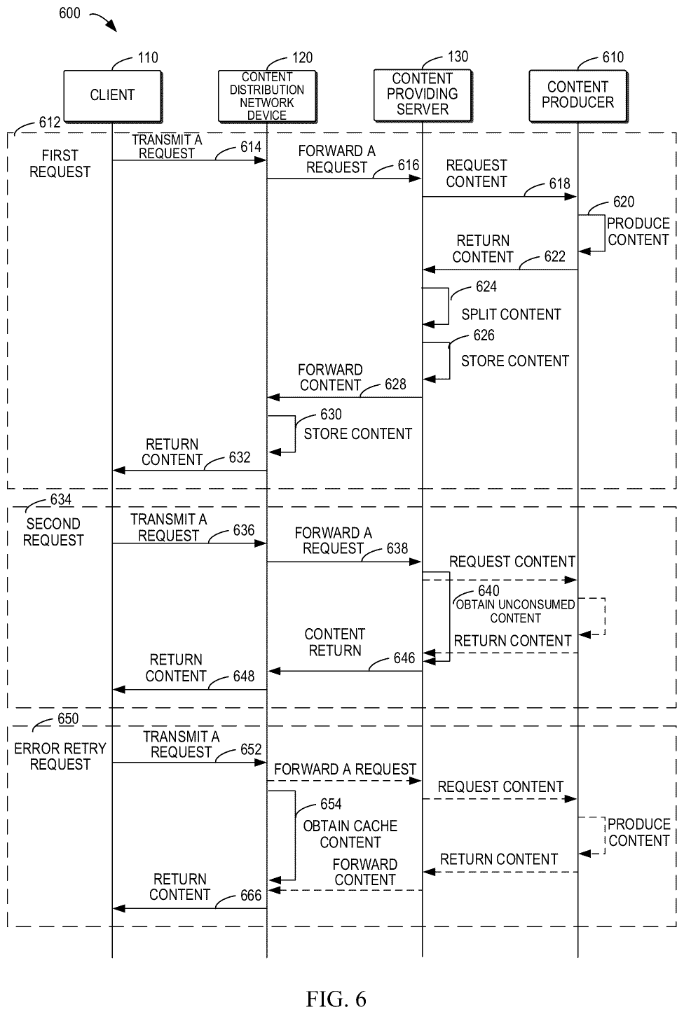

An example content transmission process is described below in connection with FIG. 6.

FIG. 6 illustrates a schematic flowchart of a content transmission process 600 according to some embodiments of the disclosure.

As shown in FIG. 6, in a process 612 of the client 110 initiating the first request, the client 110 transmits (614) a first request for content to the content distribution network device 120, where the first request includes a user identifier. The content distribution network device 120 forwards (616) the first request to the content providing server 130 in response to receiving the first request transmitted by the client 110. The content providing server 130 requests (618) the corresponding content from a content producer 610 in response to receiving the first request forwarded by the content distribution network device 120. The content producer 610 may be, for example, a database, or a server capable of providing an algorithm or recommendation mechanism.

The content producer 610, in response to receiving the request from the content providing server 130, produces (620) the corresponding content (e.g., a plurality of pieces of content) and returns (622) to the content providing server 130.

The content providing server 130 splits (624) the corresponding content into a plurality of groups of content and stores (626) the plurality of groups of content in association with the user identifier in the cache of the content providing server 130.

A first group of content in the plurality of groups of content is forwarded (628) to the content distribution network device 120. The content distribution network device 120 stores (630) the received first group of content in association with the request identifier in a cache of the content distribution network device 120. The content distribution network device 120 returns (632) the first group of content to client 110.

Next, in a process 634 of the client 110 initiating a second request, the client 110 transmits (636) a second request for the content to the content distribution network device 120, where the second request includes the user identifier.

The content distribution network device 120 forwards (638) the second request to the content providing server 130 in response to receiving the second request transmitted by the client 110. In response to receiving the second request forwarded by the content distribution network device 120, the content providing server 130 may directly obtain (640) unconsumed second group of content from the stored plurality of groups of content without requesting the corresponding content from the content producer 610 (represented by the dotted line in FIG. 6).

The content providing server 130 returns (646) the second group of content to the content distribution network device 120. In response to receiving the second group of content, the content distribution network device 120 returns (648) it to client 110.

Next, in the process 650 of an error retry request initiated by the client 110, the client 110 transmits (652) a request for content to the content distribution network device 120, the request including the request identifier.

In response to receiving the request including the request identifier from the client 110, the content distribution network device 120 may directly obtain (654) one stored group of content corresponding to request identifier without requesting corresponding content from the content providing server 130 and the content producer 610. The obtained group of content corresponding to the request identifier is returned (666) to the client 110.

### Example Apparatus and Apparatus

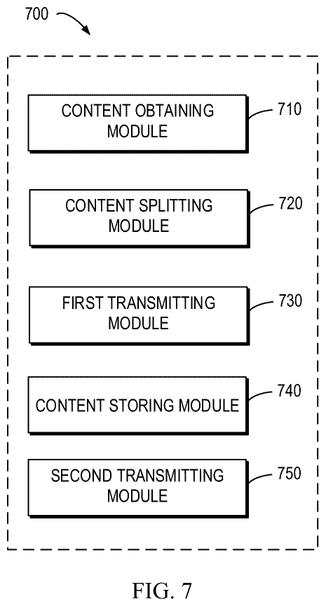

FIG. 7 is a schematic structural block diagram of a content transmission apparatus 700 according to some embodiments of the disclosure. The apparatus 700 may be implemented at the content distribution network device 120 or the content providing server 130 of FIG. 1. The various modules/components in the apparatus 700 may be implemented by hardware, software, firmware, or any combination thereof.

As shown in FIG. 7, the apparatus 700 includes a content obtaining module 710, a content splitting module 720, a first transmitting module 730, a content storing module 740, and a second transmitting module 750. The content obtaining module 710 is configured to obtain, in response to receiving a first request for content from a client, a plurality of pieces of content, wherein the first request comprises a user identifier. The content splitting module 720 is configured to split the plurality of pieces of content into a plurality of groups of content. The first sending module 730 is configured to transmit a first group of content in the plurality of groups of content to the client. The content storing module 740 is configured to store other groups of contents in the plurality of groups of contents. The second sending module 750 is configured to transmit, in response to receiving a second request comprising the user identifier for the content from the client, a second group of content in the stored other groups of content to the client.

In some embodiments, the content storing module 740 may be further configured to store the other groups of content in association with the user identifier.

In some embodiments, the apparatus 700 may include an indicating module configured to transmit, to the client, an indication indicating that the first group of content is part of the plurality of groups of content.

In some embodiments, the apparatus 700 may be implemented at the content providing server 130. In these embodiments, the content obtaining module 710 may be further configured to generate a plurality of pieces of content in response to receiving the first request from the client.

In some embodiments, the apparatus 700 may be implemented at the content distribution network device 120. In these embodiments, the content obtaining module 710 may be further configured to forward the first request received from the client to the content providing server; and receive the plurality of pieces of content from the content providing server.

In some embodiments, the request includes a hypertext transfer protocol request.

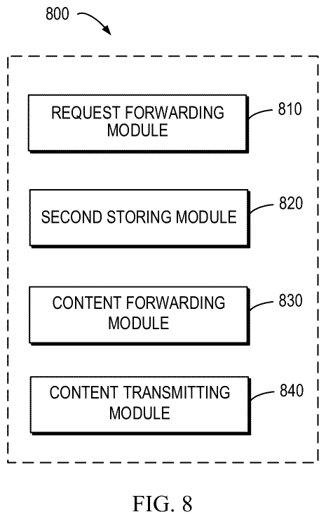

FIG. 8 is a schematic structural block diagram of a content transmission apparatus 800 according to some other embodiments of the disclosure. The apparatus 800 may be implemented in the content distribution network device 120 of FIG. 1. The various modules/components in the apparatus 800 may be implemented by hardware, software, firmware, or any combination thereof.

As shown in FIG. 8, the apparatus 800 includes a request forwarding module 810, a second storing module 820, a content forwarding module 830, and a content transmitting module 840. The request forwarding module 810 is configured to forward, in response to receiving a request for content from a client, forwarding the request to a content providing server, wherein the request includes a request identifier. The second storing module 820 is configured to store, in response to receiving a group of content from the content providing server, the group of content. The content forwarding module 830 is configured to forward the group of content to the client. The content transmitting module 840 is configured to transmit, in response to receiving another request comprising the request identifier for the content from the client, the stored group of content to the client.

In some embodiments, the second storage module 820 may be further configured to store the group of content in association with the request identifier.

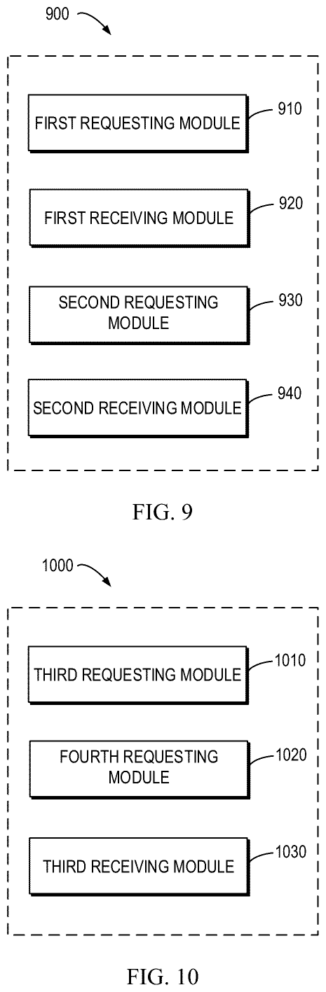

FIG. 9 illustrates a schematic structural block diagram of a content transmission apparatus 900 according to still other embodiments of the disclosure. The apparatus 900 may be implemented at the client 110 of FIG. 1. The various modules/components in the apparatus 900 may be implemented by hardware, software, firmware, or any combination thereof.

As shown in FIG. 9, the apparatus 900 includes a first requesting module 910, a first receiving module 920, a second requesting module 930, and a second receiving module 940. The first request module 910 is configured to transmit a first request for content to a content distribution network, the first request comprising a user identifier, where the first request includes a user identifier. The first receiving module 920 is configured to receive a first group of content in a plurality of groups of content from the content distribution network. The second request module 930 is configured to transmit a second request for the content to the content distribution network, the second request including the user identifier. The second receiving module 940 is configured to receive a second group of content in the plurality of groups of content from the content distribution network.

In some embodiments, the first receiving module 920 may be further configured to receive, from the content distribution network, an indication indicating that the first group of content is part of the plurality of groups of content.

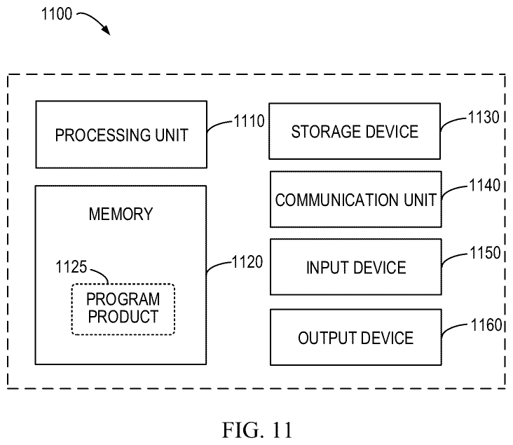

FIG. 10 illustrates a schematic structural block diagram of a content transmission apparatus 1000 according to still other embodiments of the disclosure. The apparatus 1000 may be implemented at the client 110 of FIG. 1. The various modules/components in the apparatus 1000 may be implemented by hardware, software, firmware, or any combination thereof.

As shown in FIG. 10, the apparatus 1000 includes a third requesting module 1010, a fourth requesting module 1020, and a third receiving module 1030. The third requesting module 1010 is configured to transmit a request for content to a content distribution network, the request including a request identifier. The fourth request module 1020 is configured to transmit, in response to determining that an error occurs with the request, another request for content to the content distribution network, the another request comprising the request identifier. The third receiving module 1030 is configured to receive receiving a group of content from the content distribution network.

FIG. 11 illustrates a block diagram of an electronic device 1100 in which one or more embodiments of the disclosure may be implemented. It shall be understood that the electronic device 1100 shown in FIG. 11 is merely exemplary and should not constitute any limitation on the functionality and scope of the embodiments described herein. The electronic device 1100 shown in FIG. 11 may be used to implement the electronic device 110 of FIG. 1.

As shown in FIG. 11, the electronic device 1100 is in the form of a general-purpose electronic device. Components of the electronic device 1100 may include, but are not limited to, one or more processors or processing units 1110, a memory 1120, a storage device 1130, one or more communications units 1140, one or more input devices 1150, and one or more output devices 1160. The processing unit 1110 may be an actual or virtual processor and can perform various processes according to programs stored in the memory 1120. In a multiprocessor system, a plurality of processing units execute computer executable instructions in parallel, so as to improve the parallel processing capability of the electronic device 1100.

The electronic device 1100 typically includes a number of computer storage media. Such media may be any available media that are accessible by electronic device 1100, including, but not limited to, volatile and non-volatile media, removable and non-removable media. The memory 1120 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 11 medium such as a flash drive, a magnetic disk, or any other medium that can be used to store information and/or data (e. g., training data for training) and that can be accessed within the electronic device 1100.

The electronic device 1100 may further include additional removable/non-removable, volatile/nonvolatile storage media. Although not shown in FIG. 11, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 1120 may include a computer program product 1125 having one or more program modules configured to perform various methods or actions of various embodiments of the disclosure.

The communication unit 1140 implements communication with other electronic devices through a communication medium. In addition, functions of components of the electronic device 1100 may be implemented by a single computing cluster or a plurality of computing machines, and these computing machines can communicate through a communication connection. Thus, the electronic device 1100 may operate in a networked environment using logical connections to one or more other servers, network personal computers (PCs), or another network node.

The input device 1150 may be one or more input devices such as a mouse, keyboard, trackball, etc. The output device 1160 may be one or more output devices such as a display, speaker, printer, etc. The electronic device 1100 may also communicate with one or more external devices (not shown) such as a storage device, a display device, or the like through the communication unit 1140 as required, and communicate with one or more devices that enable a user to interact with the electronic device 1100, or communicate with any device (e. g., a network card, a modem, or the like) that enables the electronic device 1100 to communicate with one or more other electronic devices. Such communication may be performed via an input/output (I/O) interface (not shown).

According to an exemplary implementation of the disclosure, a computer readable storage medium is provided, on which a computer-executable instruction is stored, wherein the computer executable instruction is executed by a processor to implement the above-described method. According to an exemplary implementation of the disclosure, there is also provided a computer program product, which is tangibly stored on a non-transitory computer readable medium and includes computer-executable instructions that are executed by a processor to implement the method described above.

Aspects of the disclosure are described herein with reference to flowchart and/or block diagrams of methods, apparatus, devices and computer program products implemented in accordance with the disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/we claim:

1. A method for content transmission, comprising:
in response to receiving a first request for content from a client, obtaining a plurality of pieces of content, wherein the first request comprises a user identifier;
splitting the plurality of pieces of content into a plurality of groups of content;
transmitting a first group of content in the plurality of groups of content to the client;
storing other groups of content in the plurality of groups of content; and
in response to receiving a second request comprising the user identifier for the content from the client, transmitting a second group of content in the stored other groups of content to the client.

2. The method of claim 1, wherein the storing comprises:
storing the other groups of content in association with the user identifier.

3. The method of claim 1, further comprising:
transmitting, to the client, an indication indicating that the first group of content is part of the plurality of groups of content.

4. The method of claim 1, wherein the method is performed by a content providing server, and obtaining the plurality of pieces of content comprises:
in response to receiving the first request from the client, generating the plurality of pieces of content.

5. The method of claim 1, wherein the method is performed by a content distribution network device, and obtaining the plurality of pieces of content comprises:
forwarding the first request received from the client to a content providing server; and
receiving the plurality of pieces of content from the content providing server.

6. The method of any of claim 1, wherein the request comprises a hypertext transfer protocol request.

7. An electronic device, comprising:
at least one processing unit; and
at least one memory, the at least one memory being coupled to the at least one processing unit and storing instructions for execution by the at least one processing unit, the instructions, when executed by the at least one processing unit, causing the electronic device to perform a method for content transmission, the method comprising:
in response to receiving a first request for content from a client, obtaining a plurality of pieces of content, wherein the first request comprises a user identifier;
splitting the plurality of pieces of content into a plurality of groups of content;
transmitting a first group of content in the plurality of groups of content to the client;
storing other groups of content in the plurality of groups of content; and
in response to receiving a second request comprising the user identifier for the content from the client, transmitting a second group of content in the stored other groups of content to the client.

8. The electronic device of claim 7, wherein the storing comprises:
storing the other groups of content in association with the user identifier.

9. The electronic device of claim 7, further comprising:
transmitting, to the client, an indication indicating that the first group of content is part of the plurality of groups of content.

10. The electronic device of claim 7, wherein the method is performed by a content providing server, and obtaining the plurality of pieces of content comprises:
in response to receiving the first request from the client, generating the plurality of pieces of content.

11. The electronic device of claim 7, wherein the method is performed by a content distribution network device, and obtaining the plurality of pieces of content comprises:
forwarding the first request received from the client to a content providing server; and
receiving the plurality of pieces of content from the content providing server.

12. The electronic device of any of claim 7, wherein the request comprises a hypertext transfer protocol request.

13. A non-transitory computer-readable storage medium having a computer program stored thereon, the computer program being executable by a processor to implement a method for content transmission, the method comprising:
in response to receiving a first request for content from a client, obtaining a plurality of pieces of content, wherein the first request comprises a user identifier;
splitting the plurality of pieces of content into a plurality of groups of content;
transmitting a first group of content in the plurality of groups of content to the client;
storing other groups of content in the plurality of groups of content; and
in response to receiving a second request comprising the user identifier for the content from the client, transmitting a second group of content in the stored other groups of content to the client.

14. The non-transitory computer-readable storage medium of claim 13, wherein the storing comprises:
storing the other groups of content in association with the user identifier.

15. The non-transitory computer-readable storage medium of claim 13, further comprising:
transmitting, to the client, an indication indicating that the first group of content is part of the plurality of groups of content.

16. The non-transitory computer-readable storage medium of claim 13, wherein the method is performed by a content providing server, and obtaining the plurality of pieces of content comprises:
in response to receiving the first request from the client, generating the plurality of pieces of content.

17. The non-transitory computer-readable storage medium of claim 13, wherein the method is performed by a content distribution network device, and obtaining the plurality of pieces of content comprises:
forwarding the first request received from the client to a content providing server; and
receiving the plurality of pieces of content from the content providing server.

18. The non-transitory computer-readable storage medium of any of claim 13, wherein the request comprises a hypertext transfer protocol request.
